(19) United States
(12) Patent Application Publication
(10) Pub. No.: US 2012/0247237 A1
(43) Pub. Date: Oct. 4, 2012

(54) SENSOR AND BONDING AGENT FOR SAME

(75) Inventors: Hisayoshi ISHIBASHI, Tokyo (JP); Hirokazu SUZUKI, Tokyo (JP); Akihiko NISHIMURA, Kyoto (JP); Yukihiro SHIMADA, Fukui (JP)

(73) Assignees: JAPAN ATOMIC ENERGY AGENCY, Ibaraki (JP); KUMAGAI GUMI CO., LTD, Fukui (JP)

(21) Appl. No.: 13/315,627

(22) Filed: Dec. 9, 2011

(30) Foreign Application Priority Data
Mar. 31, 2011 (JP) 2011-078469

(51) Int. Cl. G01D 21/00; B32B 7/04; B32B 7/02

(52) U.S. Cl. 73/866.5; 428/212

(57) ABSTRACT

A sensor and bonding agent for the sensor wherein thickness of the bonding agent interposed between the sensor and measuring object can be kept uniform to maintain uniform bonding force of the bonding agent and a peeling phenomenon of the bonding agent occurring due to a difference in thermal expansion between the measuring object and bonding agent and/or between the bonding agent and the sensor can be prevented. The sensor is attached, through the bonding agent, to a high-temperature measuring object, include a sensor main body having a detecting section, a block body constructed by integrally forming the sensor main body using a molding process. The block body is made of a ceramic-based bonding material that the same as a material forming the bonding agent and, on a side of the measuring object of the block body, a bonding surface of the bonding agent is formed.

### BACKGROUND OF THE INVENTION

1. Field of the Invention

The present invention relates to a sensor for measuring temperatures, distortion, and the like of a measuring object and to a bonding agent for the sensor and particularly to the sensor to be attached, through the bonding agent, to a high temperature measuring object and to the bonding agent for the sensor to be used to attach the sensor to the high temperature measuring object.

2. Description of the Related Art

Conventionally, a sensor is used to measure temperatures, distortion, vibration, and the like of a high temperature measuring object such as pipes or the like, for example, in a nuclear power plant (see, for example, Patent Reference 1 “Japanese Patent Application Laid-open No.2001-296110” and Patent Reference 2 “Japanese Patent Application Publication No. 2008-534982”). In the sensor of this type, generally, the sensor on which a bonding agent is pasted is attached directly to the high temperature object.

However, the conventional sensor has problems. That is, due to flexibility of the conventional sensor, it is difficult to stick a bonding agent, with a uniform thickness, between the sensor and a measuring object and, therefore, difficult to keep uniform bonding force of the bonding agent. Moreover, since a coefficient of linear expansion of each of the sensor, bonding agent, and measuring object is different from one another, as a temperature of the measuring object rises, there is an increasing risk of the occurrence of a peeling phenomenon of the bonding agent caused by the difference of thermal expansion between the measuring object and bonding agent and/or between the bonding agent and sensor.

### SUMMARY OF THE INVENTION

In view of the foregoing, it is an object of the present invention to provide a sensor and a bonding agent for the sensor which can keep uniform the thickness of the bonding agent interposed between the sensor and measuring object, thus maintaining bonding force of the bonding agent uniform and can prevent a peeling phenomenon of the bonding agent occurring due to a difference in thermal expansion between the measuring object and bonding agent and/or between the bonding agent and the sensor.

According to a first aspect of the present invention, there is provided a sensor to be attached, through a bonding agent, to a high temperature measuring object, including a sensor main body having a detecting section and a block body constructed by integrally forming the sensor main body using a molding process, wherein the block body is made of a ceramic-based bonding material being the same as a material forming the bonding agent and, on a side of the measuring object of the block body, a bonding surface of the bonding agent is formed.

According to a second aspect of the present invention, there is provided the sensor wherein the sensor main body has a woven fabric formed by weaving a warp and weft in a manner in which the warp and weft intersect approximately at right angels and an optical fiber is contained in at least either of the warp or weft forming the fabric.

According to a third aspect of the present invention, there is provided the bonding agent for the sensor to be used for attaching the sensor to the high temperature measuring object, including a plurality of bonding materials stacked in layers, wherein each of the bonding materials has a different coefficient of liner expansion between a linear expansion coefficient of the measuring object and a linear expansion coefficient of the block body and wherein, on a bonding surface side of the block body, a bonding material having a linear expansion coefficient being the same as that of the block body is disposed and the bonding materials are stacked in layers in a manner in which, as the block body comes close to the measuring object, the coefficient of linear expansion of the bonding material gradually becomes near to that of the measuring object.

By configuring as above, thickness of the bonding agent interposed between the sensor and measuring object can be kept uniform. Moreover, various excellent effects can be obtained, which includes the prevention of a peeling phenomenon of the bonding agent occurring due to a difference in thermal expansion between the measuring object and bonding agent and/or between the bonding agent and the sensor.

### BRIEF DESCRIPTION OF THE DRAWINGS

FIG. 1 is a perspective view showing the sensor and the bonding agent for the sensor according to the embodiment of the present invention.

FIG. 2 is a plan view showing the sensor and the bonding agent for the sensor according to the embodiment of the present invention.

FIG. 3 is a perspective view showing a modified example of the bonding agent for the sensor according to the embodiment of the present invention.

FIG. 4 is an arrow view of FIG. 3.

FIG. 5 is a side view showing a bonding material for the bonding agent for the sensor according to the embodiment of the present invention.

### DESCRIPTION OF THE PREFERRED EMBODIMENTS

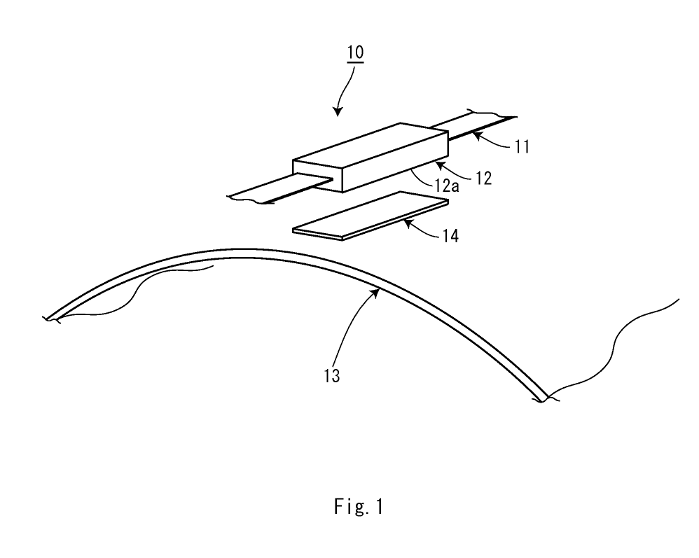

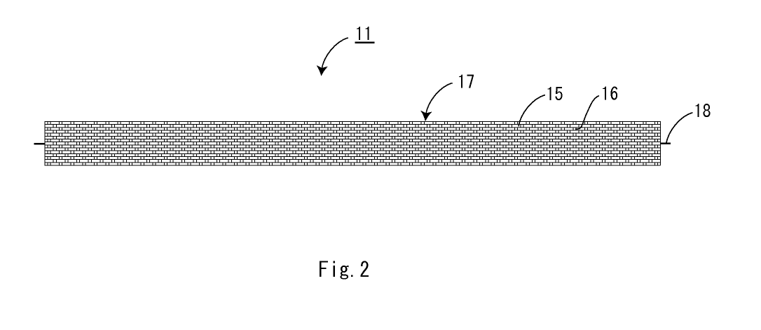

Hereinafter, a sensor and a bonding agent for the sensor of the embodiment of the present invention are described by referring to drawings. FIG. 1 is a perspective view showing the sensor and bonding agent for the sensor according to the embodiment of the present invention. FIG. 2 is a plan view showing the sensor and bonding agent for the sensor according to the embodiment of the present invention.

As shown in FIG. 1, the sensor 10 of the embodiment of the present invention has a band-shaped sensor main body 11 and a block main body 12 disposed in a predetermined position of the sensor main body 11, wherein the sensor 10 can be attached, through a bonding agent applied to the block main body 12, to high temperature measuring objects such as special stainless steel pipes, equipment, or the like, which have temperatures reading as high as the maximum at about 650° C., of a fast reactor in a nuclear power plant.

The sensor main body 11, as shown in FIG. 2, has a woven fabric 17 formed by weaving a warp 15 and weft 16 in a manner in which the warp 15 and wefts 16 intersect approximately at right angles. These warp 15 and weft 16 of the woven fabric 17 form fiber bundles one piece of which includes one piece of an optical fiber 18 and is formed of, for example, one piece of the optical fiber 18 and ninety-nine pieces of glass fibers. Moreover, as materials for the warp 15 and weft 16, for example, a carbon fiber, aramid fiber, glass fiber, alumina fiber, and a synthetic fiber such as nylon, vinylon, or polyester can be used, however, it is preferable that, in order to protect the optical fiber 18, a high-strength fiber having tensile strength being higher than that of the optical fiber 18 is employed. The optical fiber 18 may be contained not only in the warp 15 but also in the weft 16; that is, all that is required is that the optical fiber 18 is contained in at least either of the warp 15 or weft 16. It is possible that the material for the warp 15 and weft 16 is changed in such a case where the glass fiber is used as the warp 15 and the carbon fiber as the weft 16 or it is also possible that fibers of different types are combined in such a case where, as the material for the warp 15 and weft 16, a plurality of types of fibers are used in a combined manner.

The optical fiber 18, according to the embodiment of the present invention, functions as an FBG (Fiber Bragg Grating)sensor. The FBG sensor is a known sensor comprising a plurality of detecting sections (not shown) configured by applying ultraviolet rays to cores of the optional fibers 18, which is designed to measure distortion, pressure, temperature, and the like of the measuring object 13 by observing a change in a wavelength of light reflecting in these detecting sections.

Moreover, the sensor body 11 is preferably provided with a symbol (not shown) to identify a position for installing the block body 12 and a position of the detecting section by giving color thereto or printing a mark or the like thereon, thus enabling the installation of the block body 12 at the attaching position of the measuring object 13 and enabling the block body 12 and detecting sections to be reliably positioned at the measuring position where the measuring object 13 is measured by the detecting sections, thereby making it possible to further improve measuring accuracy of the sensor 10.

The block body 12 is formed so as to be flat and rectangular solid—shaped by solidifying a ceramic-based bonding material being the same as a material forming the bonding agent 14 and also is constructed by integrally forming the sensor body 11 using a molding process. On the side of the measuring object 13 of the block body 12, a bonding surface 12a is formed in a manner to conform to a surface shape of the high temperature measuring surface 13 to which the bonding surface 12a is bonded.

The bonding agent 14 is the ceramic-based bonding agent and has a property in which the bonding agent 14 becomes ceramic-like when solidified. When the bonding agent 14 is bonded to the bonding surface 12a of the block body 12, the sensor 10 is fixed in a predetermined position of the high temperature measuring object 13 and is adapted to measure a temperature, distortion, vibration, and the like of the measuring object 13.

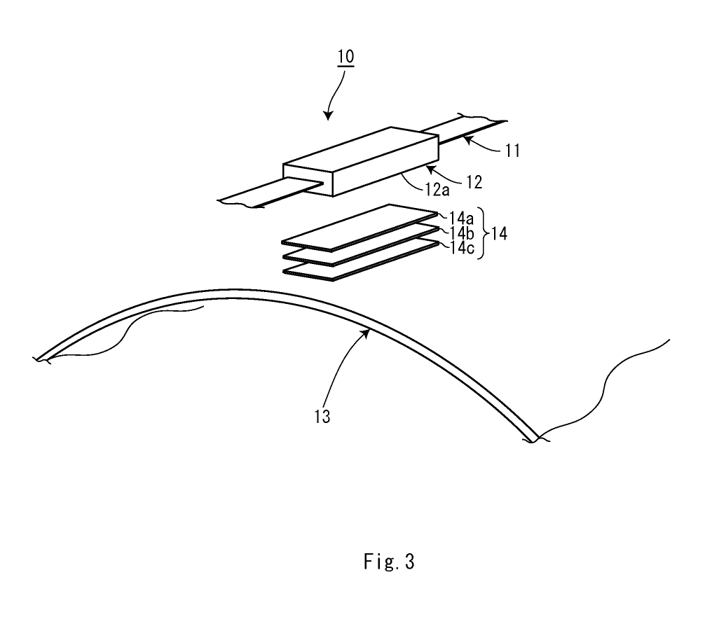

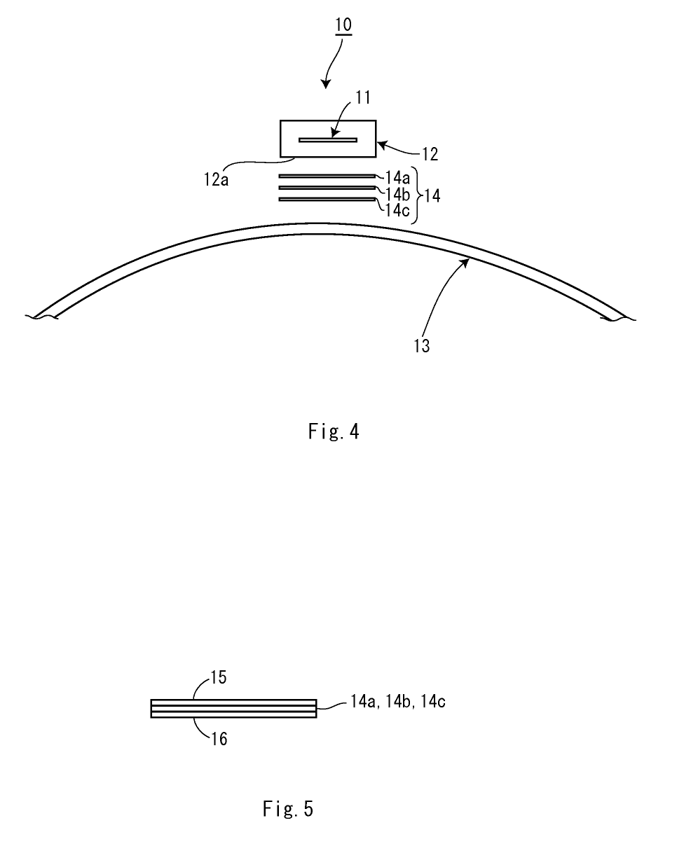

In addition, the bonding agent 14, as shown in FIGS. 3 and 4, may be configured by stacking, in layers, three kinds of bonding materials 14a, 14b, and 14c. Each of the three kinds of bonding materials 14a, 14b, and 14c has a different coefficient of linear expansion between the coefficient of linear expansion of the measuring object 13 and the coefficient of linear expansion of the block body 12. On the bonding surface side 12a of the block body 12, the first bonding material 14a having the coefficient of linear expansion being the same as that of the block body 12 is disposed and the second bonding material 14b and third bonding material 14c are stacked in layers in a manner in which, as the block body 12 comes close to the measuring object 13, the coefficient of linear expansion of each of the bonding materials 14b and 14c gradually becomes near to that of the measuring object 13.

More concretely, when it is assumed that the measuring object 13 is, for example, a stainless steel pipe, the coefficient of linear expansion of the first bonding material 14a is set to be 8×10⁻⁶ and the second bonding material 14b is set to be 13×10⁻⁶, and the third bonding material 14c is set to be 18×10⁻⁶, and the block body 12 may be formed of the material being the same as that for the first bonding material 14a.

In the case where the bonding agent 14 for the sensor is configured by the three kinds of bonding materials 14a, 14b, and 14c laminated as above, each of the bonding materials 14a, 14b, and 14c may be housed in the measuring position of the measuring object 13 in a state where films 15 and 16 such as Teflon are pasted on both sides of each of the bonding materials 14a, 14b, and 14c.

In this case, in order for the sensor 10 to be fixed on the measuring object 13, first, the film 16 pasted on one surface of the third bonding material 14c is peeled off and then the third bonding material 14c is bonded to a predetermined position of the measuring object 13. Then, the film 15 pasted on another surface of the third bonding material 14c is peeled off and the film 16 pasted on one surface of the second bonding material 14b is peeled off and the third bonding material 14c and second bonding material 14b are bonded to each other and, further, the film 15 pasted on another surface of the second bonding material 14b and the film 16 pasted on one surface of the first bonding material 14a are peeled off respectively and the second bonding material 14b and first bonding material 14a are bonded to each other. Finally, the film 15 pasted on another surface of the first bonding material 14a is peeled off and the bonding surface 12a of the block body 12 is bonded to the first bonding material 14a and the sensor 10 is fixed in a predetermined position of the measuring object 13.

Thus, by housing the bonding material 14, with the films 15 and 16 being pasted on both sides of each of the bonding materials 14a, 14b, and 14c, in a measuring position of the measuring object 13, operations of bonding of the bonding agent 14 can be made easy and reliable and also operations of attaching the sensor 10 to the measuring object 13 can be made simple.

As described above, in the sensor 10 of the embodiment of the present invention, since the bonding agent 14 is not applied directly to the sensor body 11, but is applied to the bonding surface 12a of the block body 12, which enables the bonding agent 14 to be easily and reliably applied, with its thickness kept uniform, between the block body 12 and measuring object 13, thus making it possible to maintain its uniform bonding power of the bonding agent 14.

Moreover, when the bonding agent 14 is constructed with three kinds of bonding agents 14a, 14b, and 14c each having a different linear expansion coefficient laminated in a manner in which, as the block body 12 comes close to the measuring object 13, the coefficients of linear expansion of the bonding materials 14b and 14c gradually become near to that of the measuring object 13, the coefficient of linear expansion of the bonding agent becomes near to the measuring object 13, even when, with an increase in a temperature of the measuring object 13, the measuring object 13 is thermally expanded, each of the bonding materials 14a, 14b, and 14c can accommodate thermal expansion in a phased manner and, therefore, no peeling phenomenon of the bonding agent 14 occurs, due to a difference in thermal expansion, between the measuring object 13 and third bonding material 14c, between the third bonding material 14c and the second bonding material 14b, between the second bonding material 14b and first bonding material 14a, and between the first bonding material 14a and block body 12, whereby the bonding agent 14 fully exhibits its predetermined bonding power. As a result, distortion, temperature, and the like of the measuring object 13 are surely propagated to the detecting section of the optical fiber 18, thus enabling the measuring accuracy of the sensor 10 to be improved and reliability of the sensor 10 to be enhanced.

Moreover, the bonding agent 14 for the sensor may be configured by not only three kinds of bonding materials 14a, 14b, and 14c but also two or four and over plural bonding materials each having a different linear expansion coefficient and can enhance various effects described above by stacking more kinds of bonding materials in layers.

Further, according to the sensor 10 of the embodiment of the present invention, the optical fiber 18 of the sensor main body 11 is protected by the fiber bundle, which prevents the optical fiber 18 from being broken or cut when the sensor 10 is attached to the measuring object 13, as a result, enabling the improvement of durability of the sensor 10.

Still further, the sensor 10 can be conveyed in a state of being wound up and, therefore, operations of conveyance can be made simplified. The sensor 10 can be extended by fusion-connecting end portions of the optical fiber 18 to one another. The sensor 10 can be attached easily to the measuring object 13 in a manner to conform to its size, shape, and the like.

In the above embodiment of the present invention, it is not necessary to say that the example in which the optical fiber 18 functions as the FBG sensor is explained, however, one functional example of the sensor body 11 is merely described; that is, the sensor main body 11 can be applied not only to a microbend-type sensor by which distortion of a measuring object is measured by detecting a change in amounts of transmittance of light, to a rayleigh scattering-type sensor by which distortion of a measuring object is measured by detecting a change in amounts of reflection of light, and to a case where the optical fiber 18 functions as a sensor other than the FBG sensor such as a sensor which measures vibration, temperature, pressure, ultrasounds, neutral beams, gamma rays or the like, but also to a sensor having no optical fiber 18.

Examples of various features/aspects/components/operations have been provided to facilitate understanding of the disclosed embodiments of the present invention. In addition, various preferences have been discussed to facilitate understanding of the disclosed embodiment(s) of the present invention. It is to be understood that all examples and preferences disclosed herein are intended to be non-limiting.

Although selected embodiment(s) of the present invention have been shown and described, it is to be understood the present invention is not limited to the described embodiment(s). Instead, it is to be appreciated that changes may be made without departing from the principles and spirit of the invention, the scope of which is defined by the claims and the equivalents thereof.

What is claimed is:

1. A sensor to be attached, through a bonding agent, to a high temperature measuring object, comprising:
a sensor main body having a detecting section; and
a block body constructed by integrally forming the sensor main body using a molding process;
wherein the block body is made of a ceramic-based bonding agent being the same as a material forming the bonding agent and, on a side of the measuring object of the block body, a bonding surface of the bonding agent is formed.

2. The sensor according to claim 1, wherein the sensor main body has a woven fabric formed by weaving a warp and weft in a manner in which the warp and weft intersect approximately at right angels and an optical fiber is contained in at least either of the warp or weft forming the fabric.

3. A bonding agent for the sensor to be used for attaching the sensor stated in claim 1 to the high temperature measuring object, comprising:
a plurality of bonding materials stacked in layers;
wherein each of the bonding materials has a different coefficient of liner expansion between a linear expansion coefficient of the measuring object and a linear expansion coefficient of the block body and wherein, on a bonding surface side of the block body, a bonding material having a linear expansion coefficient being same as that of the block body is disposed and the bonding materials are stacked in layers in a manner in which, as the block body comes close to the measuring object, the coefficient of linear expansion of the bonding material gradually becomes near to that of the measuring object.

4. A bonding agent for the sensor to be used for attaching the sensor stated in claim 2 to the high temperature measuring object, comprising:
a plurality of bonding materials stacked in layers;
wherein each of the bonding materials has a different coefficient of liner expansion between a linear expansion coefficient of the measuring object and a linear expansion coefficient of the block body and wherein, on a bonding surface side of the block body, a bonding material having a linear expansion coefficient being same as that of the block body is disposed and the bonding materials are stacked in layers in a manner in which, as the block body comes close to the measuring object, the coefficient of linear expansion of the bonding material gradually becomes near to that of the measuring object.
